(19) United States
(12) Patent Application Publication
(10) Pub. No.: US 2013/0118608 A1
(43) Pub. Date: May 16, 2013

(54) SYSTEM AND METHOD FOR TRAPPING AND NEUTRALIZING CONDENSATE IN A CONDENSING GAS APPLIANCE

(71) Applicants: Chris Holiday, Gilmanton Iron Works, NH (US); Bertram L. Walters, Duxbury, MA (US); Richard A. Williamson, Rochester, NH (US)

(72) Inventors: Chris Holiday, Gilmanton Iron Works, NH (US); Bertram L. Walters, Duxbury, MA (US); Richard A. Williamson, Rochester, NH (US)

(73) Assignee: Laars Heating Systems Company, Rochester, NH (US)

(21) Appl. No.: 13/463,000

(22) Filed: May 3, 2012

Related U.S. Application Data
(60) Provisional application No. 61/537,678, filed on Sep. 22, 2011.

(51) Int. Cl. F16T 1/00

(52) U.S. Cl. CPC F16T 1/00
USPC 137/409

(57) ABSTRACT

A drain system is configured to collect condensate from flue gas generated by a condensing fuel-fired appliance. The drain system includes a drain body defining an inlet positioned to receive condensate in the drain body, a drain opening positioned to deliver condensate from the drain body, a passage extending between the inlet and the drain opening, and a seat surface disposed within the passage. A float moves within the passage of the drain body at a location between the inlet of the drain body and the seat surface of the drain body. The float moves to a position contacting the seat surface defined by the drain body to block the flow of flue gas through the passage of the drain body when there is little or no condensate in the passage. A neutralizing agent is positioned along the passage of the drain body for contact with condensate in the passage.

### CROSS REFERENCE TO RELATED APPLICATION

This patent application claims priority to U.S. Provisional Patent Application No. 61/537,678, filed Sep. 22, 2011, which is incorporated by reference herein in its entirety.

### FIELD OF THE INVENTION

This invention relates to a condensate trap for neutralizing condensate produced by a condensing gas appliance, and a method for using the condensate trap.

### BACKGROUND OF THE INVENTION

Commercial and residential water heaters, boilers and pool heaters typically heat water by generating tens of thousands, and even hundreds of thousands, of BTUs per hour. For many years, manufacturers of these water heaters have sought to increase the efficiency of the exchange of this heat energy from burned fuel to the water contained in the water heater. Accordingly, maximized heat exchange efficiency has long been sought by commercial and residential appliance manufacturers.

As heat exchange efficiency increases, however, such increased efficiency gives rise to the problems associated with condensation of water vapor from the products of combustion. More specifically, upon burning of a mixture of fuel and air, water is formed as a constituent of the products of combustion. It is recognized that as the temperature of the combustion gases decreases as the result of successful exchange of heat from the combustion gases to water in the appliance, the water vapor within the combustion gases tends to be condensed in greater quantities. In other words, as the temperature of the combustion gases decreases as a direct result of increasingly efficient exchange of heat energy to the water, the amount of condensate forming on the heat exchange surfaces also increases.

In Application Ser. No. 12/395,894, filed Mar. 2, 2009 and incorporated herein by reference in its entirety, a system and method is described for configuring a water heater to drain condensate from combustion products. A drain port is positioned at an elevation below a portion of an exhaust passageway to drain condensate from the exhaust passageway.

Application Ser. No. 61/444,341, filed Feb. 18, 2011 and also incorporated herein by reference in its entirety, describes water heaters and boilers configured to improve at least one of their performance, efficiency, cost and reliability.

Despite such developments, there continues to be a need for improvements related to the management of the condensation formed by condensing appliances such as water heaters.

### SUMMARY OF THE INVENTION

According to one aspect of the invention, a drain system (otherwise referred to herein as a condensate trap) is configured to collect condensate from flue gas generated by a condensing fuel-fired appliance. The drain system includes a drain body defining an inlet positioned to receive condensate in the drain body, a drain opening positioned to deliver condensate from the drain body, a passage extending between the inlet and the drain opening, and a seat surface disposed along the passage. A float is positioned for movement within the passage of the drain body at a location between the inlet of the drain body and the seat surface of the drain body. The float is configured to move to a position contacting the seat surface defined by the drain body in order to substantially block the passage of flue gas through the passage of the drain body when there is little or no condensate in the passage of the drain body. A neutralizing agent is positioned along the passage of the drain body for contact with condensate in the passage.

According to another aspect of the invention, a drain system comprises a drain body and a connector that is configured to removably connect the drain body to a condensate collector of a condensing fuel-fired appliance.

According to another aspect of the invention, a kit for collecting condensate from flue gas generated by a condensing fuel-fired appliance is provided. The kit comprises a drain body and a connector for removably connecting the drain body to a condensate collector that is either connected to or forms part of a condensing fuel-fired appliance.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity.

Included in the drawings are the following figures:

FIG. 1 is a cross-sectional perspective view of a condensate trap according to one exemplary embodiment of the invention.

FIG. 2 depicts the condensate trap of FIG. 1 including arrows showing the pathway of condensate through the condensate trap.

FIG. 3 is a top perspective view of the condensate trap of FIGS. 1 and 2 mounted to a condensate collection tray.

FIG. 4 is bottom perspective view of the condensate trap of FIGS. 1 and 2 mounted to the condensate collection tray, wherein a segment of the condensate trap is cut-away to reveal mechanical engagement between the condensate trap and the condensate collection tray.

FIG. 5 is a top perspective view of the collection tray component of the condensate trap of FIG. 3.

FIG. 6 is a top perspective view of an embodiment of a drain system.

FIG. 7 is a top perspective view of an embodiment of an outer body component of the drain system of FIG. 6.

FIG. 8 is a top perspective view of an embodiment of an inner body component of the drain system of FIG. 6.

FIG. 9 is a top perspective view of an embodiment of an outer gasket component of the drain system of FIG. 6.

FIG. 10 is a top perspective view of an embodiment of an inner gasket component of the drain system of FIG. 6.

FIG. 11 is a top perspective view of an embodiment of a neutralizing agent component of the drain system of FIG. 6.

FIG. 12 is a front perspective view of an embodiment of a filter component of the drain system of FIG. 6.

FIG. 13 is a top perspective view of a drain system including a condensate trap mounted to a condensate tray according to another exemplary embodiment of the invention.

FIG. 14 is a side elevation view of the drain system of FIG. 13.

FIG. 15 is a cross-section view of the drain system of FIG. 14 taken along the lines 15-15 including arrows showing the pathway of condensate through the condensate trap.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Application Ser. No. 61/467,722, filed Mar. 25, 2011 and also incorporated herein by reference in its entirety, describes a condensing fuel-fired appliance having a fuel burner configured to generate flue gas. The details of that condensing fuel-fired appliance are applicable to the instant invention. The condensing fuel-fired appliance described herein also has a condensate trap positioned to collect condensate from the flue gas. The condensate trap described herein differs from the condensate trap described in Application Ser. No. 61/467,722.

Referring generally to the figures, according to one aspect of the invention, a drain system (otherwise referred to herein as a condensate trap 10) is configured to collect condensate from flue gas generated by a condensing fuel-fired appliance. The drain system 10 and 300 includes a drain body 12 and 301 defining an inlet 18 and 318 positioned to receive condensate in the drain body 12 and 301, a drain opening 25 and 350 positioned to deliver condensate from the drain body 12 and 301, a passage 20, 35 and 335, 331, 333, 339 extending between the inlet 18 and 318 and the drain opening 25 and 350, and a seat surface 42 and 342 disposed within the passage 20, 35 and 335, 331, 333, 339. A float 37 and 337 is positioned for movement within the passage 35 and 335 of the drain body 12 and 301 at a location between the inlet 18 and 318 of the drain body 12 and 301 and the seat surface 42 and 342 of the drain body 12 and 301. The float 37 and 337 is configured to move to a position contacting the seat surface 42 and 342 defined by the drain body 12 and 301 in order to substantially block the flow of flue gas through the passage 20 and 331 of the drain body 12 and 301 when there is little or no condensate in the passage 35 and 335 of the drain body 12 and 301. A neutralizing agent 15 is positioned along the passage 20 and 339 of the drain body 12 and 301 for contact with condensate in the passage 20 and 339.

According to another aspect of the invention, a drain system 10 and 300 comprises a drain body 12 and 301 and a connector 21 and 306 that is configured to removably connect the drain body 12 and 301 to a condensate collector 50 and 304 of a condensing fuel-fired appliance.

According to another aspect of the invention, a kit for collecting condensate from flue gas generated by a condensing fuel-fired appliance is provided. The kit comprises a drain body 301 and a connector 21 and 306 for removably connecting the drain body 12 and 301 to a condensate collector 50 and 304 that is either connected to or forms part of a condensing fuel-fired appliance.

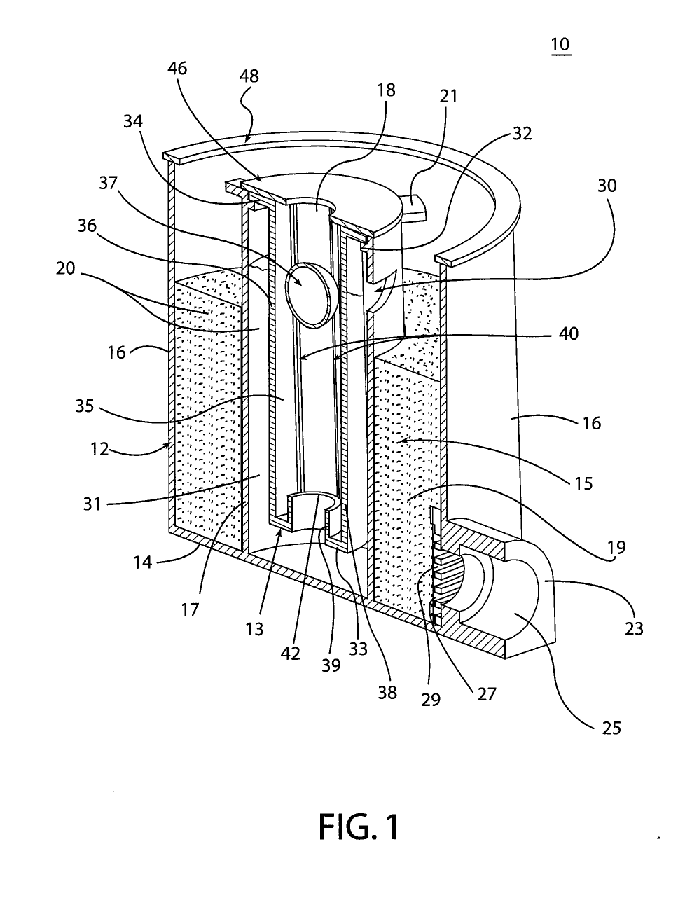

Referring now to FIG. 1 in particular, FIG. 1 is a cross-sectional perspective view of a condensate trap 10 according to one exemplary embodiment of the invention. The condensate trap 10 may also be referred to herein as a drain system. The condensate trap 10 generally includes a drain body 12 defining a substantially enclosed interior region, and a ball float assembly 13 mounted within the enclosed interior region of the drain body 12. The ball float assembly 13 generally includes a moveable ball float 37 that cooperates with a valve seat 42 to prevent the flow of flue gases through the trap 10 while permitting the passage of condensate therethrough.

The drain body 12 of the trap 10 includes a circular base surface 14, an outer wall 16 extending in a vertical direction from the perimeter edge of the base surface 14, and a central wall 17 extending in a vertical direction from the base surface 14. The central wall 17 is coaxial with the outer wall 12 and is spaced radially interior of the outer wall 12, thereby forming an annular space 19 between the outer wall 16 and the central wall 17.

In an assembled form of the trap 10, neutralizing agent 15 is positioned within the annular space 19 to neutralize flue gas condensate that passes through the annular space 19. The neutralizing agent 15 may be limestone or any other neutralizing agent that is known to those of ordinary skill in the art for neutralizing the pH of a fluid passing adjacent or through it. The annular reservoir 19 forms part of a downstream condensate passage 20 that is downstream of the valve seat 42.

The outer wall 16 of the drain body 12 is cylindrical. An outlet port 23 defining a drain opening 25 is provided on the lower end of the outer wall 16. Condensate is expelled from the annular reservoir 19 of the trap 10 under gravity through the drain opening 25. The drain opening 25 of the outlet port 23 is configured to be coupled to a drain conduit (not shown) or other delivery point.

A filter 27 is disposed within the annular reservoir 19 of the drain body 12 adjacent the entrance of the drain opening 25. The filter 27 may be integrally formed with the outer wall 16 of the drain body 12, or it may be a separate component that is mounted to the interior surface of the wall 16, as shown. The filter 27 includes apertures 29 that are large enough to permit the passage of condensate through the filter 27 and into the drain opening 25, yet small enough to inhibit the passage of the neutralizing agent 15 through the filter 27 and into the drain opening 25.

The central wall 17 of the drain body 12 is cylindrical. One or more apertures 30, through which condensate can pass, are defined on the central wall 17 at a location near the top end of the central wall 17. The apertures 30 fluidly connect the annular reservoir 19 with the space 31 that is defined between the central wall 17 and the ball float assembly 13.

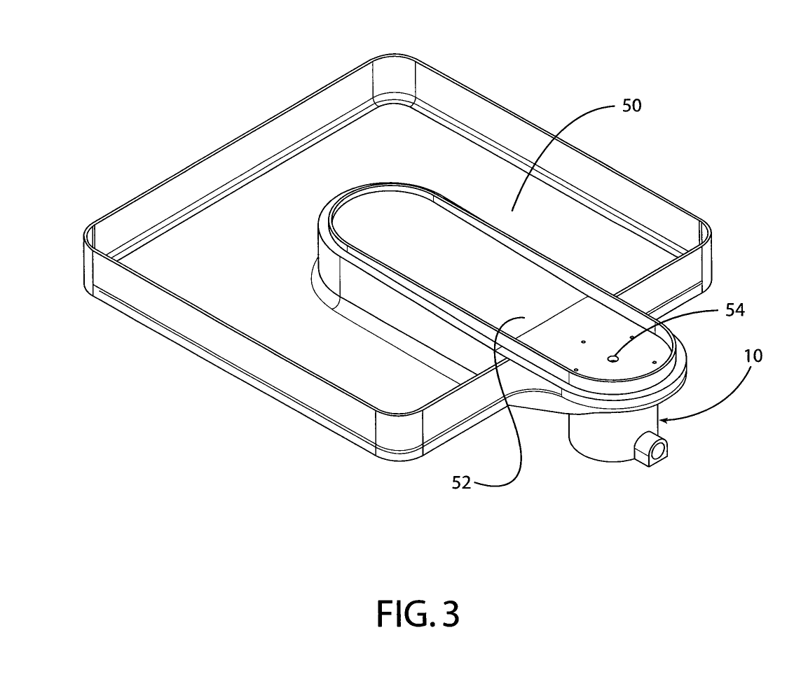

A series of outwardly extending, rectangular-shaped flanges 21 are uniformly spaced around the top edge of the central wall 17. The flanges 21 are provided for releasably coupling the trap 10 to complimentary recesses formed in a condensate tray, as will be described with reference to FIG. 3. The flanges 21 may also be referred to herein as a connector.

An annular flange 32 extends radially inward from the top end of the interior facing surface of the central wall 17. A flange 34 of the ball float assembly 13 of the condensate trap 10 is positioned on top of the annular flange 32 of the central wall 17.

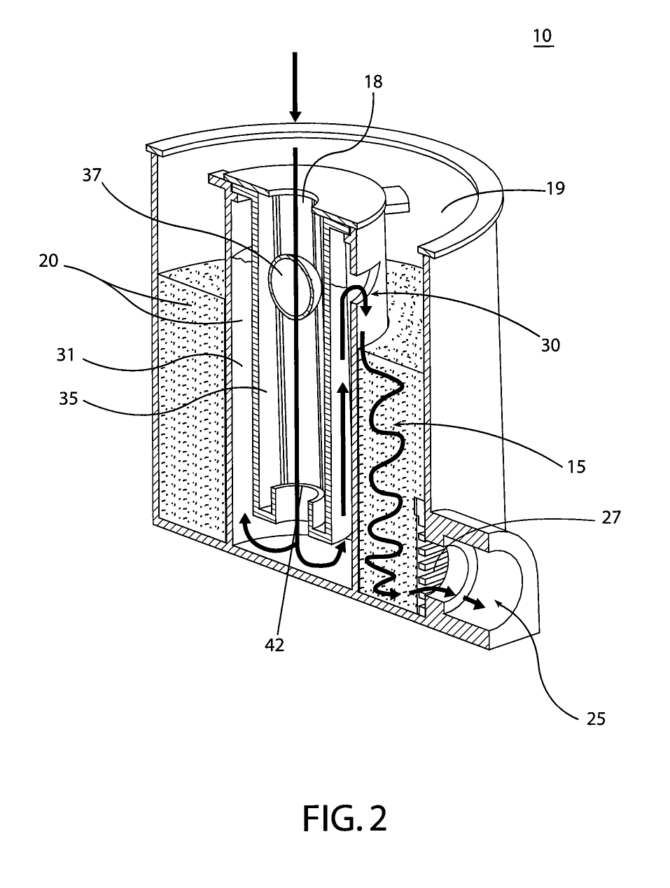

The ball float assembly 13 includes a ball float housing 36 defining a condensate inlet 18, through which condensate is delivered, and a vertically extending upstream condensate passage 35 that extends downwardly from the condensate inlet 18. The ball float 37 is movably positioned within the upstream condensate passage 35 of the housing 36 along the longitudinal axis (represented by broken lines) of the upstream condensate passage 35. The upstream condensate passage 35 is the condensate passage of the trap 10 that is upstream of the valve seat 42. As will be described later with respect to FIG. 2, the ball float 37 moves with respect to the valve seat 42 of the ball float assembly 13.

The ball float 37 is a spherical-shaped ball that is composed of a buoyant material. The ball float 37 may be any commercially available spherical-shaped ball that is composed of a buoyant material and sized to fit within the upstream condensate passage 35.

Interior wall 39 of the ball float housing 36 is a cylindrically-shaped wall that extends from the inner edge of the annular base surface 33 of the ball float housing 36. The interior wall 39 extends in a vertical direction to an elevation beneath the top surface of the outer wall 38. A valve seat 42 is defined on the top edge of the interior wall 39, upon which the float valve 37 rests to block the passage of flue gas through the valve seat 42 when there is little or no condensate in the upstream condensate passage 35 of the drain body 12. It should be understood that the float valve 37 rises and falls as level of condensate changes in the upstream condensate passage 35 of the drain body 12. The valve seat 42 is coaxial with the longitudinal axes of the upstream condensate passage 35 and the condensate inlet 18.

Outer wall 38 of the ball float housing 36 is a cylindrically-shaped wall that extends in a vertical direction from the outer edge of the annular base surface 33. The outer wall 38 surrounds the interior wall 39 of the ball float housing 36. The condensate inlet 18 is defined by the opening formed on the top end of the outer wall 38. The upstream condensate passage 35, which extends from the condensate inlet 18, is defined by the cylindrical area circumscribed by the outer wall 38.

Outer wall 38 of the ball float housing 36 includes a plurality of ball float guides 40 provided in the form of protruding ribs that are uniformly spaced along the interior facing surface of the outer wall 38. Each ball float guide 40 optionally extends along the entire length of the outer wall 38. The ball float guides 40 together assist in guiding and stabilizing the ball float 37 as it moves vertically along the longitudinal axis of the ball float housing 36.

Outer wall 38 of the ball float housing 36 includes a flange 34 that extends in a radially outward direction (i.e., away from the longitudinal axis of the condensate trap 10) from the top end of the outer facing surface of the outer wall 38.

In an assembled form of the condensate trap 10, the flange 34 is positioned on top of the flange 32 of the central wall 17 of the drain body 12. Also, the longitudinal axis of the ball float housing 36 is coaxially aligned with the longitudinal axis of the drain body 12. In the assembled form, the base surface 33 is spaced from the base surface 14 of the drain body 12 by a pre-determined distance, and the outer wall 38 of the ball float housing 36 is also spaced from the central wall 17 of the drain body 12 by a predetermined distance, thereby forming the space 31 through which condensate can pass. The space 31 and the annular reservoir 19 together form the downstream condensate passage 20 of the trap 10 that is downstream of the valve seat 42.

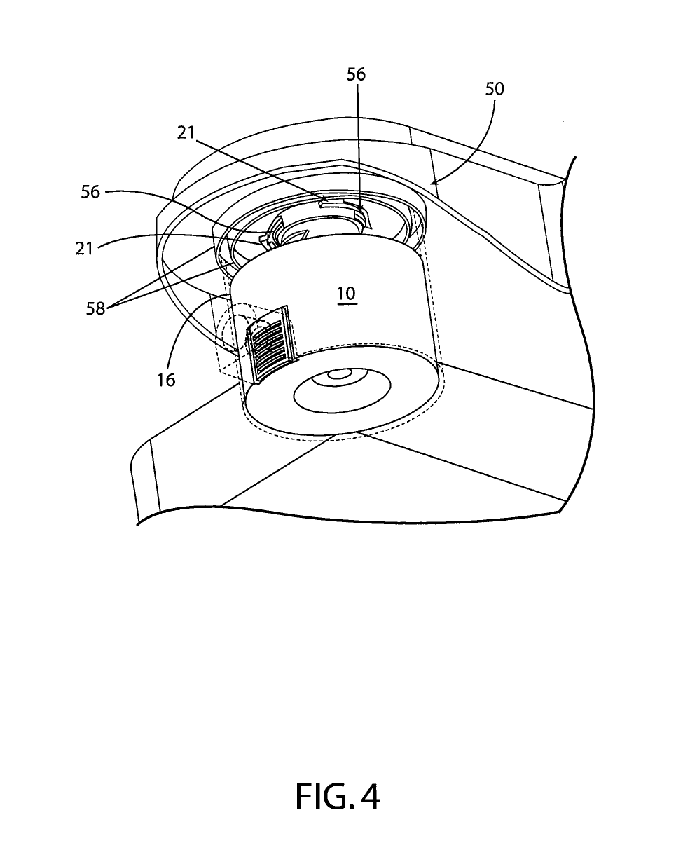

A first annular gasket 46 is partially positioned on the flange 21 of the central wall 17 and the top surface of the flange 34. Upon assembling the trap 10 onto the condensate tray (see FIG. 4), the first gasket 46 creates a fluid tight seal between the trap 10 and the tray to prevent the condensate and flue gasses from bypassing the ball float assembly 13 and directly entering the annular reservoir 19 of the trap 10. The first gasket 46 also prevents condensate already in the annular reservoir 19 from inadvertently re-entering the inlet 18 of the ball float assembly 13. It should be understood that the aperture in the gasket 46 permits the entry of condensate into the inlet 18 of the trap 10.

A second gasket 48 is positioned on the top edge of the outer wall 16 of the trap 10. Upon assembling the trap 10 onto the condensate tray (see FIG. 4), the second gasket 48 creates a fluid tight seal between the condensate tray and the top edge of the wall 16 to prevent condensate from inadvertently escaping the trap 10 at the interface between the condensate tray and the outer wall 16 of the trap 10.

The condensate trap 10 can be formed from a variety of materials and by a variety of forming methods. For example, the materials of the condensate trap 10 are either plastic materials or some other metallic or non-metallic materials. Preferably, the selected material or materials are compatible with the aggressive effects of flue gas condensate and are thermally and physically stable at flue gas temperatures. The preferred method of manufacture of the components of condensate trap 10 is by injection molding. Other manufacturing methods can be selected for producing the desirable shape and properties depending on the materials selected, cost considerations, and other factors.

FIGS. 3 and 4 are perspective views of the condensate trap 10 of FIGS. 1 and 2 shown mounted to the bottom surface of a condensate tray 50. The condensate tray 50 includes a sloping condensate collection surface 52 on its top surface that is positioned beneath the condensing appliance. Condensate produced by the condensing appliance collects on the condensate collection surface 52 of the tray 50. The condensate collection surface 52 slopes in a downward direction toward a weep hole 54 formed on the collection surface 52, thereby channeling the collected condensate towards the weep hole 54. The weep hole 54 is substantially aligned with the inlet 18 of the trap 10 such that the condensate that passes through the weep hole 54 is delivered into the inlet 18 of the trap 10 where it forms a water seal preventing flue gas bypass, then neutralized.

In FIG. 4, the outer wall 16 of the condensate trap 10 is cut-away to reveal the mechanical engagement between the flanges 21 of the condensate trap 10 and complimentary slots 56 of the condensate tray 50. The complimentary slots 56 are formed on a cylindrical wall that extends downwardly from the bottom surface of the condensate tray 50. The top edge of the outer wall 16 of the trap 10 and the gasket 48 are positioned in an annular space that is formed between two cylindrical walls 58 that also extend from the bottom surface of the tray 50.

To assemble the condensate trap 10 onto the tray 50, the flanges 21 of the trap 10 are initially aligned with respective slots 56 on the tray 50. The trap 10 is then rotated until the flanges 21 are seated in the respective slots 56, thereby locking the trap 10 into place and compressing the gaskets 46 and 48 between the trap 10 and the bottom surface of the tray 50.

Removal of the condensate trap for 10 for serviceability is achieved by reversing the rotation of the trap 10 until the flanges 21 of trap 10 are aligned with respective slots 56 on tray 50. The limestone 15 is a perishable item within the assembly and needs to be replaced at periodic intervals and this semi-turn method of assembly provides an ease-of-use feature for the service technician.

Referring now to FIGS. 2 and 3, the general operation of the condensate trap 10 will now be described according to exemplary aspects of the invention. FIG. 2 depicts the condensate trap of FIG. 1, whereby arrows show the pathway of condensate through the trap.

In operation, flue gas condensate is created as the result of combustion in the condensing appliance (see the condensing appliance shown in Application Ser. No. 61/467,722, for example). The condensate drains by gravity onto a collection surface 52 of a condensate tray 50 that is positioned adjacent the appliance (see FIG. 3). The collected condensate flows under gravity into the weep hole 54 of the condensate tray 50. The condensate that passes through the weep hole 54 is delivered through the inlet 18 of the trap 10 under gravity.

Upon start-up of the appliance when there is little or no condensation in the upstream condensate passage 35 of the trap 10, flue gas may enter the trap 10 through the inlet 18. However, the flue gas is completely, substantially or at least partially prevented from flowing past the valve seat 42 because the ball float 37 is positioned against the valve seat 42. As the condensate collects in the condensate passage 35, the ball float 37 rises along with level of condensate and eventually becomes separated from the valve seat 42.

As the condensate continues to collect in the upstream condensate passage 35, the buoyant ball float 37 rises above the valve seat 42 thereby permitting the condensate to drain through the valve seat 42 into the space 31 that is defined between the central wall 17 and the ball float assembly 13. It should be understood that even when the ball float 37 separates from the valve seat 42, the collected pool of condensate within the upstream condensate passage 35 of the trap 10 prevents the flue gas from traveling downstream of the valve seat 42.

As the condensate continues to collect in the space 31, the condensate ultimately rises to the level of the apertures 30 that are formed in the central wall 17. The condensate then flows through the apertures 30 and into the annular reservoir 19 whereupon the condensate comes into contact with the neutralizing agent 15. The neutralizing agent 15, which may be limestone of sufficient size that will not block the filter 27 but still allow proper rate of condensate flow through the reservoir 19, neutralizes the pH of the condensate. The condensate then passes through the filter 27 and is expelled from the trap 10 through the drain passage 25.

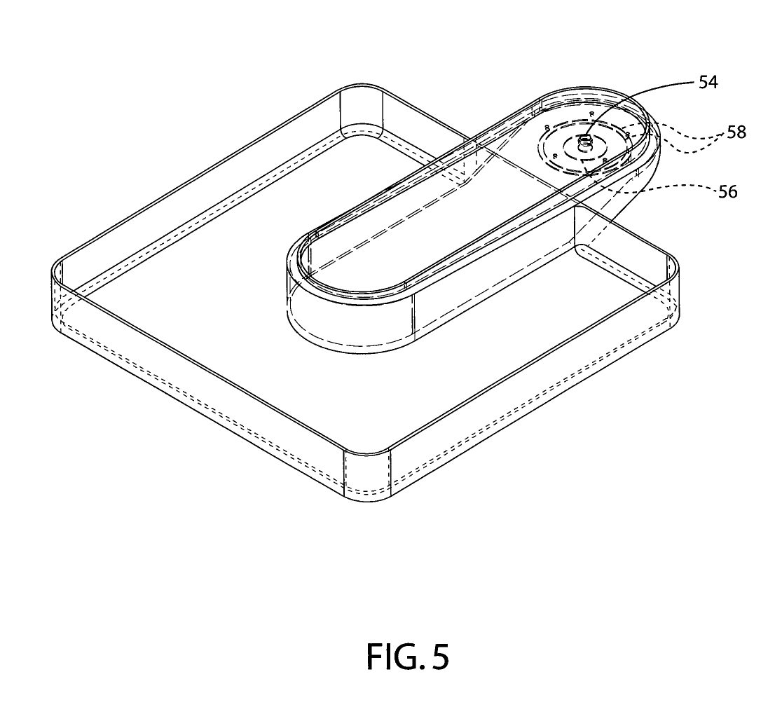

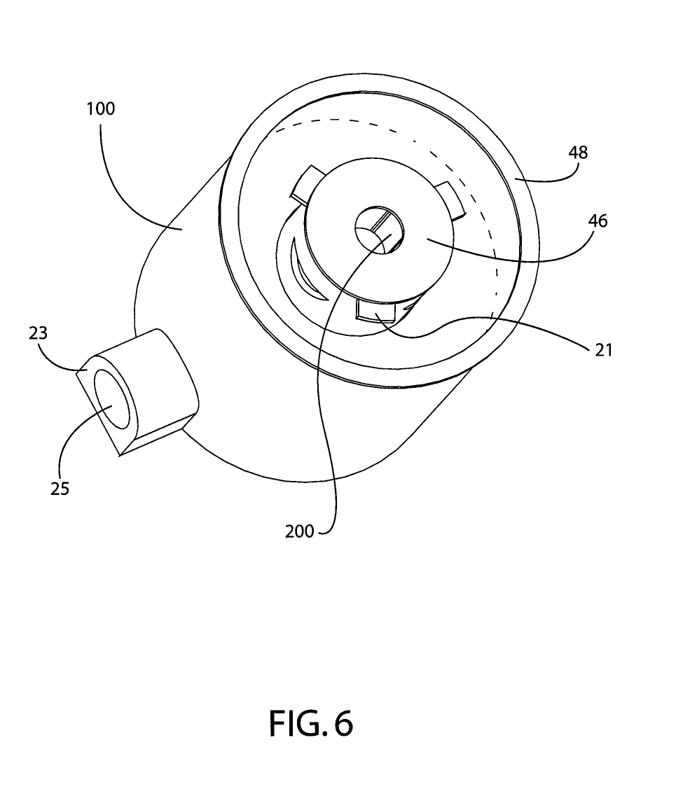

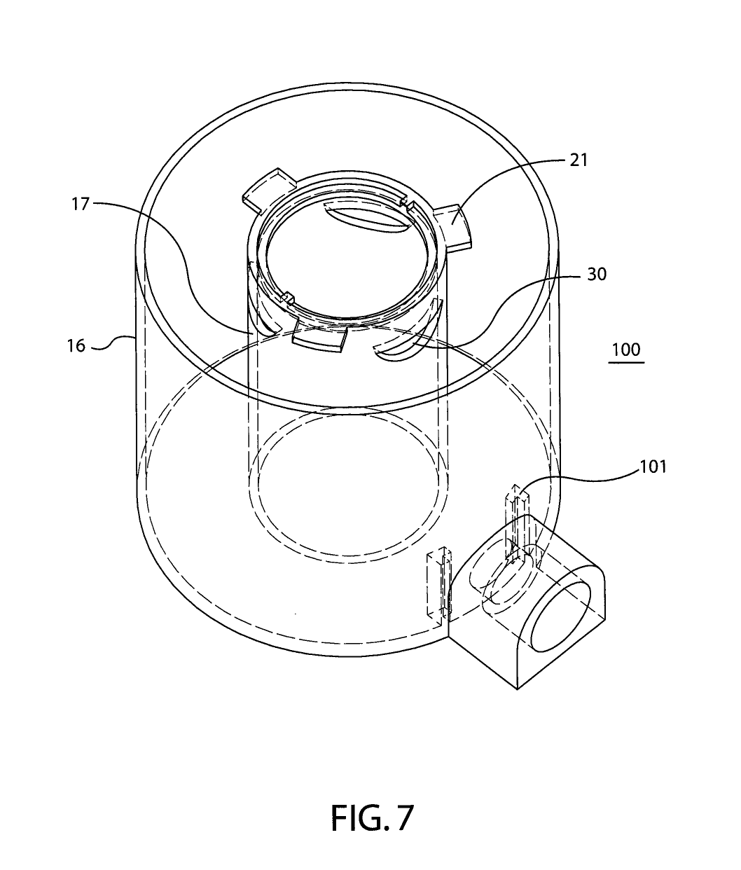

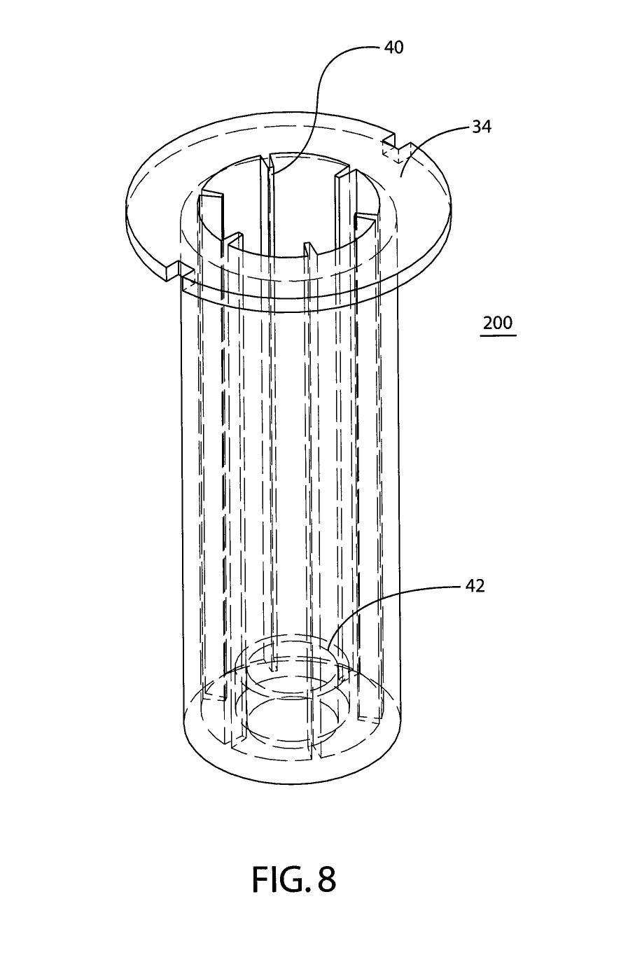

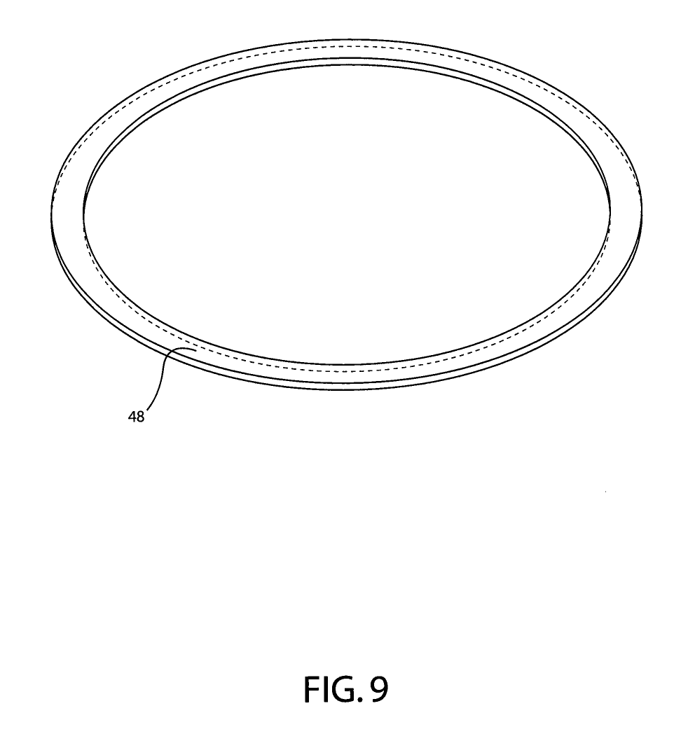

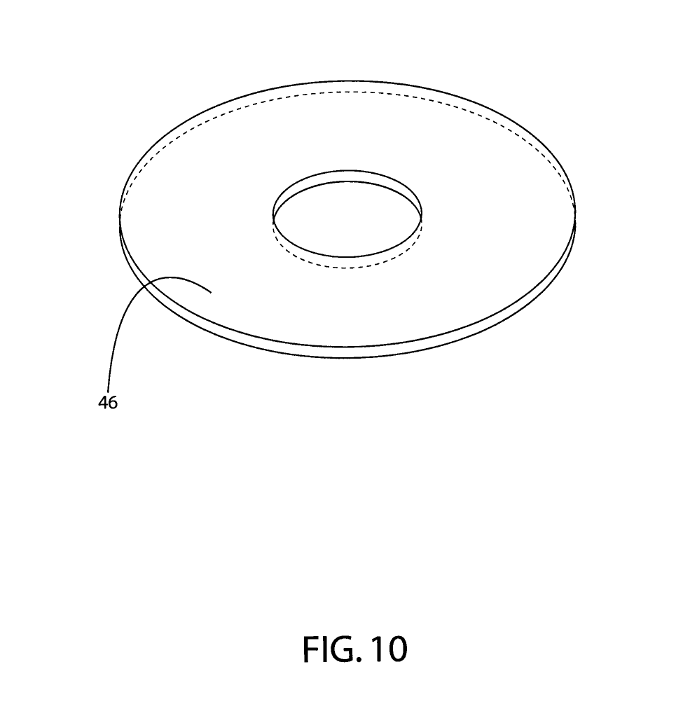

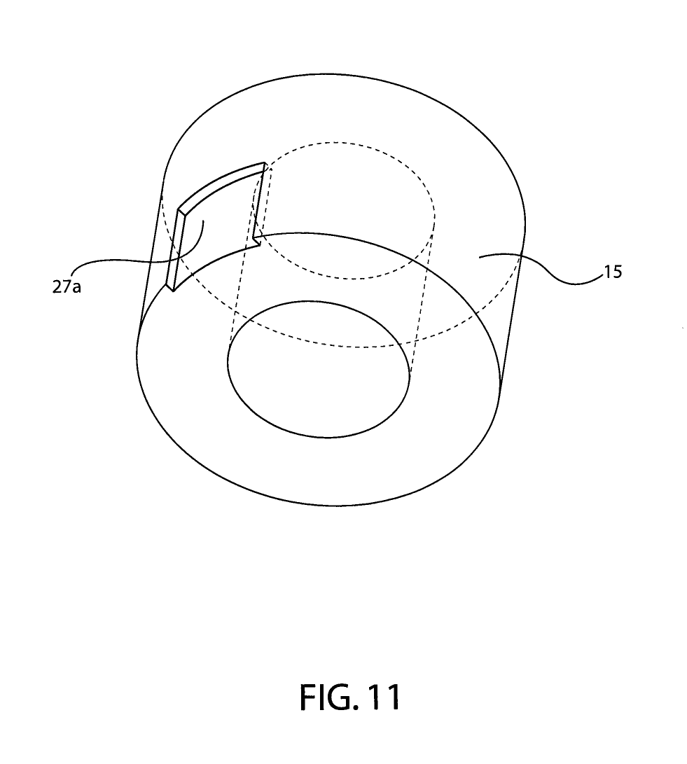

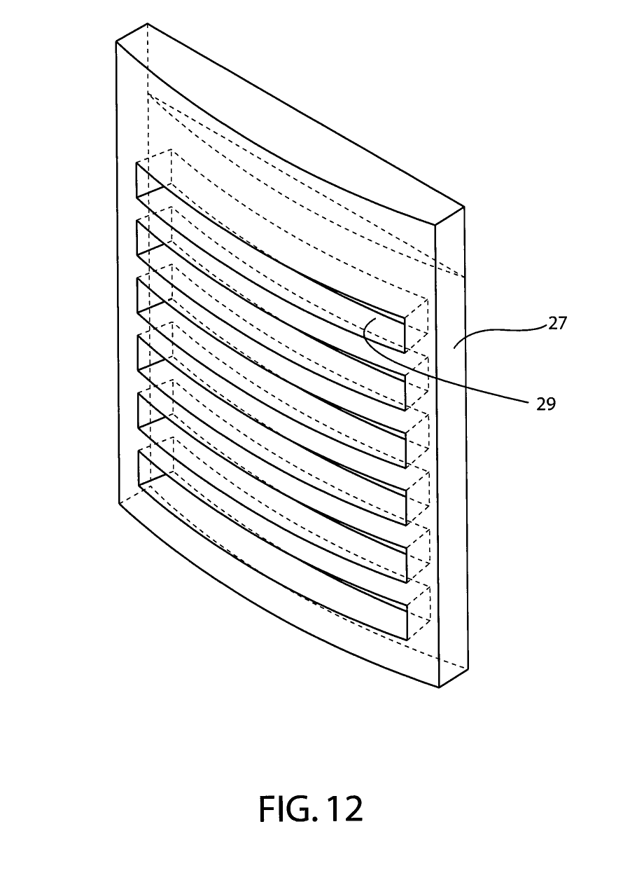

FIG. 5 is a top perspective view of the collection tray component of the condensate trap of FIG. 3, and FIGS. 6-11 illustrate an exemplary embodiment of the drain body assembly and its component parts. Specifically, FIG. 6 is a top perspective view of an embodiment of a drain system; FIG. 7 is a top perspective view of an embodiment of an outer body component 100 of the drain system of FIG. 6, which includes brackets 101 for filter component 27; FIG. 8 is a top perspective view of an embodiment of an inner body component 200 of the drain system of FIG. 6; FIG. 9 is a top perspective view of an embodiment of an outer gasket component 48 of the drain system of FIG. 6; FIG. 10 is a top perspective view of an embodiment of an inner gasket component 48 of the drain system of FIG. 6; FIG. 11 is a top perspective view of an embodiment of a neutralizing agent component 15 of the drain system of FIG. 6, including a recess 27a for the filter component 27; and FIG. 12 is a front perspective view of an embodiment of the filter component 27 of the drain system of FIG. 6.

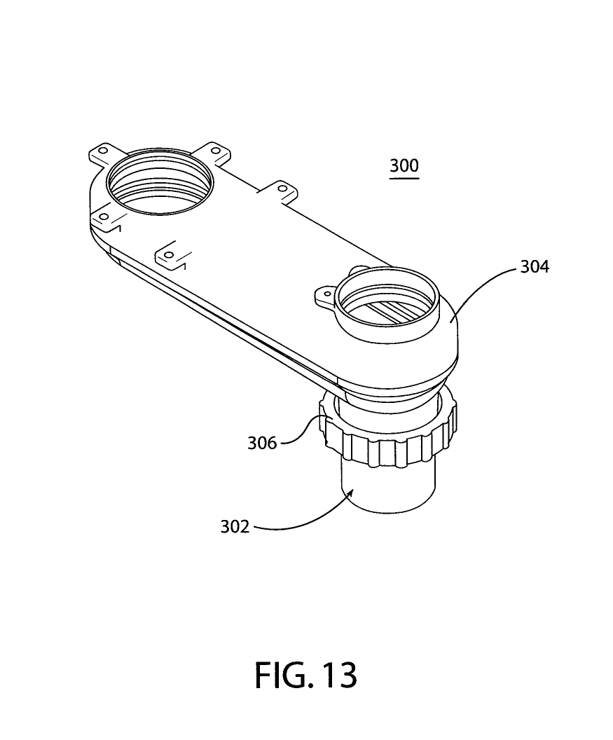

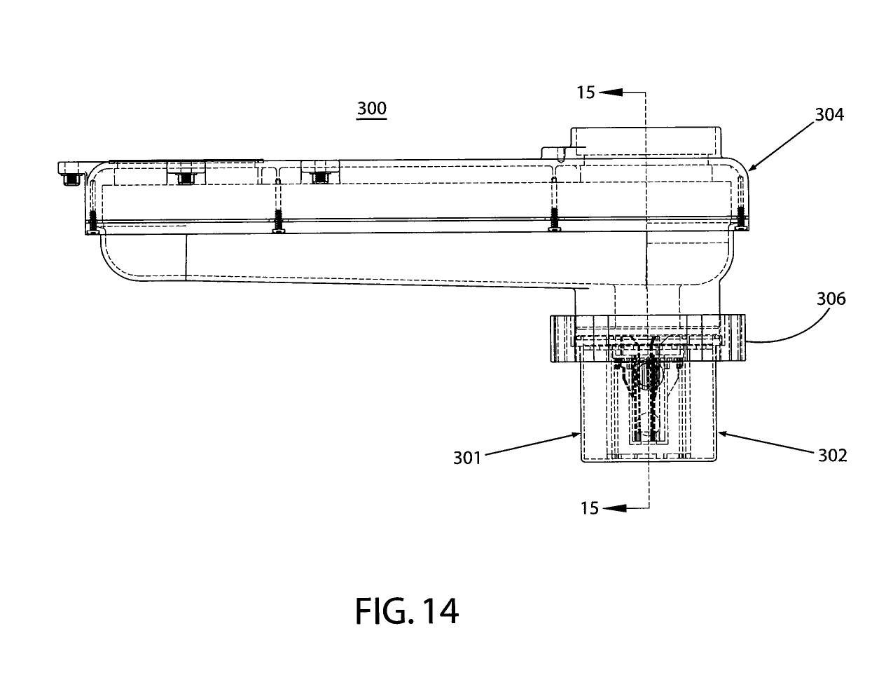

FIGS. 13-15 depict a drain system 300 including a condensate trap 302 mounted to a condensate collection tray 304, according to another exemplary embodiment of the invention. FIG. 14 is a side elevation view of the drain system 300. The drain system 300 is substantially similar to the drain system depicted in FIG. 3, and only the primary differences between those systems will be described hereinafter.

A drain body 301 of the condensate trap 302 is mounted to the tray 304 by a connector in the form of a threaded nut 306. The threaded nut 306 includes internal threads (not shown) that threadedly engage with exterior threads (not shown) that are defined on the exterior surface 308 of the tray 304. Upon mating the threads of the nut 306 with the threads of the tray 304, a shoulder 310 that is formed in the nut 306 urges a shoulder 312 that is formed on the top surface of the trap 302 against the bottom surface of the tray 304 thereby fluidly connecting the trap 302 to the tray 304. Those of ordinary skill in the art will recognize that various ways exist to removably attach the trap 302 to the tray 304.

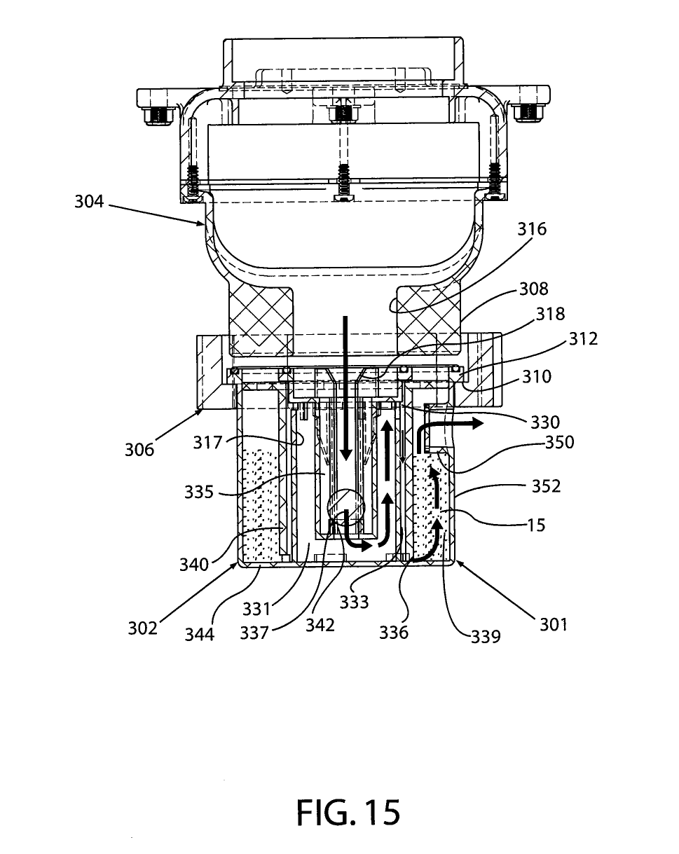

FIG. 15 is a cross-section view of the drain system 300 of FIG. 14 taken along the lines 15-15. It should be understood that the features of the trap 302 that are shown in cross-section are cylindrical in shape. FIG. 15 includes arrows showing the pathway of condensate through the condensate trap 302.

In operation, the collected condensate flows under gravity into the weep hole 316 of the condensate tray 304. The condensate that passes through the weep hole 316 is delivered through the inlet 318 of the trap 302 under gravity. Upon start-up of the appliance when there is little or no condensation in the upstream condensate passage 335 of the trap 302, flue gas may enter the trap 302 through the inlet 318. However, the flue gas is completely, substantially or at least partially prevented from flowing past the valve seat 342 because the ball float 337 is positioned against the valve seat 342. As the condensate collects in the condensate passage 335, the ball float 337 rises along with level of condensate and eventually becomes separated from the valve seat 342.

As the condensate continues to collect in the upstream condensate passage 335, the buoyant ball float 337 rises above the valve seat 342 thereby permitting the condensate to drain through the valve seat 342 into the annular passage 331. As the condensate continues to collect in the annular passage 331, the condensate ultimately rises to the level of an aperture 330 that is formed at the top end of the central wall 317. The condensate then flows through the aperture 330 and then flows downward into the annular passage 333 that is formed between the walls 340 and 317 of the trap 302.

The condensate then flows through a space 336 that is formed between the walls 340 and 344 of the trap 302 whereupon the condensate comes into contact with the neutralizing agent 15 that is positioned in the annular passage 339. As the condensate continues to collect in the annular passage 339, the condensate rises to the level of a drain opening 350 that is formed at the top end of the wall 352 of the trap 302. The condensate escapes from the trap 302 via the drain opening 350.

The passages 331, 333, 335 and 339 between the inlet 318 and the drain opening 350 together form a tortious fluid passage having meandering 180 degree turns for the flow of condensate. According to this embodiment, the neutralizing agent 15 is only positioned in the passage 339, however, the neutralizing agent 15 may be positioned in the other passages 331, 333 and 335 as well.

According to one aspect of the invention, the drain opening 350 is positioned at an elevation above the seat 342, the lower wall 344 and the neutralizing agent 15, and at an elevation that is below the nut 306. By positioning the drain opening 350 either above, at or near a top surface of the neutralizing agent 15, the condensate is forced to pass through the neutralizing agent 15 before exiting the trap 302 through the drain opening 350.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A drain system configured to collect condensate from flue gas generated by a condensing fuel-fired appliance, the drain system comprising:
a drain body defining an inlet positioned to receive condensate in the drain body, a drain opening positioned to deliver condensate from the drain body, a passage extending between the inlet and the drain opening, and a seat surface disposed within the passage;
a float positioned for movement within the passage of the drain body at a location between the inlet of the drain body and the seat surface of the drain body, the float being configured to move to a position contacting the seat surface defined by the drain body in order to substantially block the flow of flue gas through the passage of the drain body when there is little or no condensate in the passage of the drain body; and
a neutralizing agent positioned along the passage of the drain body for contact with condensate in the passage.

2. The drain system of claim 1, the drain body further defining at least one guide surface positioned to guide movement of the float along a path extending between the inlet and the seat surface.

3. The drain system of claim 1, wherein the neutralizing agent is positioned along only a portion of the passage of the drain body.

4. The drain system of claim 1, wherein the neutralizing agent is positioned adjacent the drain opening.

5. The drain system of claim 1, wherein the drain opening is positioned at an elevation that is either above, at or near a top surface of the neutralizing agent.

6. The drain system of claim 1 further comprising a connector for removably connecting the drain body to a condensate collector of the condensing fuel-fired appliance.

7. The drain system of claim 6, wherein the connector is a threaded nut that is configured to urge a surface of the drain body against a surface of the condensate collector, the threaded nut being rotatable with respect to the condensate collector and the drain body for removal and replacement of the drain body.

8. The drain system of claim 6, wherein the connector is at least one flange of the drain body that is releasably engaged by at least one slot defined in a condensate collector of the appliance, the drain body being rotatable with respect to the condensate collector for removal and replacement of the drain body.

9. A condensing fuel-fired appliance configured to generate flue gas, the condensing fuel-fired appliance including a drain system configured to collect condensate from the flue gas, the drain system comprising:
a drain body defining an inlet positioned to receive condensate in the drain body, a drain opening positioned to deliver condensate from the drain body, a passage extending between the inlet and the drain opening, and a seat surface disposed within the passage;
a float positioned for movement within the passage of the drain body at a location between the inlet of the drain body and the seat surface of the drain body, the float being configured to move to a position contacting the seat surface defined by the drain body in order to substantially block the flow of flue gas through the passage of the drain body when there is little or no condensate in the passage of the drain body; and
a neutralizing agent positioned along the passage of the drain body for contact with condensate in the passage.

10. The condensing fuel-fired appliance of claim 9, further comprising a condensate collector, the drain body being releasably coupled to the condensate collector, the drain body having at least one flange releasably engaged by at least one slot defined in the condensate collector, the drain body being rotatable with respect to the condensate collector for removal and replacement of the drain body.

11. The condensing fuel-fired appliance of claim 9, further comprising a condensate collector and a connector for removably connecting the drain body to the condensate collector.

12. The condensing fuel-fired appliance of claim 11, wherein the connector is a threaded nut that is configured to urge a surface of the drain body against a surface of the condensate collector, the threaded nut being rotatable with respect to the condensate collector and the drain body for removal and replacement of the drain body.

13. The condensing fuel-fired appliance of claim 9, wherein the drain opening is positioned at an elevation that is either above, at or near a top surface of the neutralizing agent.

14. A drain system configured to collect condensate from flue gas generated by a condensing fuel-fired appliance, the drain system comprising:
a drain body defining an inlet positioned to receive condensate in the drain body, a drain opening positioned to deliver condensate from the drain body, and a passage extending between the inlet and the drain opening; and
a connector that is configured to removably connect the drain body to a condensate collector of the condensing fuel-fired appliance.

15. The drain system of claim 14, wherein the connector is a flange of the drain body that is releasably engaged by at least one slot defined in a condensate collector of the appliance, the drain body being rotatable with respect to the condensate collector for removal and replacement of the drain body.

16. The drain system of claim 14, wherein the connector is a threaded nut that is configured to urge a surface of the drain body against a surface of the condensate collector, the threaded nut being rotatable with respect to the condensate collector and the drain body for removal and replacement of the drain body.

17. The drain system of claim 16 further comprising a condensate collector, and a threaded region provided on the condensate collector onto which a threaded region of the threaded nut is releasably connected.

18. The drain system of claim 16 wherein the surface of the drain body is an annular shoulder that extends from the drain body.

19. A kit for collecting condensate from flue gas generated by a condensing fuel-fired appliance, said kit comprising:
a drain body defining an inlet positioned to receive condensate in the drain body, a drain opening positioned to deliver condensate from the drain body, and a passage extending between the inlet and the drain opening; and
a connector for removably connecting the drain body to a condensate collector that is either connected to or forms part of the condensing fuel-fired appliance.

20. The kit of claim 19, wherein the connector is a threaded nut.

21. The kit of claim 19, further comprising a neutralizing agent configured to be positioned along the passage defined by the drain body.

22. The kit of claim 21, said neutralizing agent being removable and replaceable with respect to the drain body.
